(19) United States
(12) Patent Application Publication
(10) Pub. No.: US 2012/0313889 A1
(43) Pub. Date: Dec. 13, 2012

(54) Touch Display Apparatus

(75) Inventors: Shih-Ting Chen, Hsin-Chu (TW); Yen-Po Yeh, Hsin-Chu (TW); Chih-Liang Pan, Hsin-Chu (TW)

(73) Assignee: AU OPTRONICS CORPORATION, Hsin-Chu (TW)

(21) Appl. No.: 13/400,170

(22) Filed: Feb. 20, 2012

(30) Foreign Application Priority Data
Jun. 7, 2011 (TW) 100119801

(51) Int. Cl. G06F 3/046

(52) U.S. Cl. 345/174

(57) ABSTRACT

A touch Display apparatus is disclosed. The touch Display apparatus includes a backlight module and a sensing plate. The backlight module includes a support member, a light guide plate, and a backlight source. The support member is formed by a non-metallic material and has a bottom and a plurality of sidewalls. The sides of the bottom connect with the sidewalls respectively to form a containing space. The light guide plate is disposed in the containing space and has a light emitting surface. A side of the containing space has a light incident end. The backlight source is disposed corresponding to the light incident end in the containing space. The backlight source generates a light emitting to the light incident end. The sensing plate is disposed on a lower surface of the bottom and senses an action of an item above the support member through an electromagnetic reaction.

### BACKGROUND OF THE INVENTION

1. Field of the invention

The invention relates to a display apparatus, in particular, to a touch display apparatus using the micro cellular polyethylene terephthalate (MCPET) without any metallic material as the supporting structure of its backlight module.

2. Description of the prior art

In recent years, with the continuous progress of technology, various kinds of thin and small portable electronic products are shown on the market and attract the attention of consumers. Through the digital design, the user can arbitrarily input handwriting or drawing on the display panel of these portable electronic products, and these portable electronic products can sense the position and content of touch input through the sensing pen and the sensing plate of the display and show them on the screen.

Conventionally, the supporting structure of back iron frame or front iron frame is usually used in the panel or backlight module of the notebook. Please refer to FIG. 1. FIG. 1 illustrates a cross-sectional view of the back iron frame structure of the conventional backlight module in a prior art. As shown in FIG. 1, the sensing plate S is attached on the back surface of the display panel P.

FIG. 2 shows the design of reducing the back frame area.

Then, please refer to FIG. 3A. FIG. 3A illustrates a cross-sectional view of the front frame structure of the conventional backlight module in a prior art. As shown in FIG. 3A, because the print circuit board assembly (PBCA) also has metallic material, the sensing plate S should be disposed on the PBCA.

### SUMMARY OF THE INVENTION

In an embodiment, the touch display apparatus includes a backlight module and a sensing plate. The backlight module includes a support member, a light guide plate, and a backlight source. The support member is formed by a non-metallic material and has a bottom and a plurality of sidewalls. The sides of the bottom connect with the sidewalls respectively to form a containing space. The light guide plate is disposed in the containing space and has a light emitting surface. A side of the containing space has a light incident end. The backlight source is disposed corresponding to the light incident end in the containing space. The backlight source generates a light emitting to the light incident end. The sensing plate is disposed on a lower surface of the bottom and senses an action of an item above the support member through an electromagnetic reaction.

In an embodiment, the non-metallic material is a foam-type Polyethylene Terephthalate (PET).

In an embodiment, the plurality of sidewalls includes a first sidewall and a plurality of second sidewalls. The first sidewall is connected with a first side of the bottom and adjacent to the backlight source. The plurality of second sidewalls is connected with other sides of the bottom respectively and adjacent to the light guide plate.

In an embodiment, the first sidewall at least has a sidewall portion, and an end of the sidewall portion connects with the bottom.

In an embodiment, each second sidewall at least has a first sidewall portion, a second sidewall portion, and a third sidewall portion, two ends of the first sidewall portion connect with the bottom and the second sidewall portion respectively, two ends of the second sidewall portion connect with the first sidewall portion and the third sidewall portion respectively.

In an embodiment, the sensing plate is disposed on the lower surface of the bottom by an adhering way, and the sensing plate is an electromagnetic induction type tablet.

In an embodiment, the touch display apparatus further includes a display panel. The display panel is disposed above the backlight module.

In an embodiment, the location of a sensing region of the sensing plate disposed on the lower surface corresponds to a viewing area of the display panel, and edges of the display panel are disposed on horizontal portions of the plurality of sidewalls respectively.

In an embodiment, the touch display apparatus further includes a touch panel. The touch panel is disposed above the display panel.

Compared to the prior art, the touch display apparatus of the invention can effectively improve the metal interference issue of the conventional sensing plate, and the micro cellular polyethylene terephthalate (MCPET) without any metallic material is used as the supporting structure of its backlight module, so that the back iron frame, the reflection film, and the rubber frame in the conventional backlight module structure can be integrated and combined with the metal bracket at the LED backlight source side. Therefore, the assembling time, material types, and weight can be reduced and the strength and assembling convenience can be also considered at the same time to solve the problems occurred in prior art.

The advantage and spirit of the invention may be understood by the following detailed descriptions together with the appended drawings.

### BRIEF DESCRIPTION OF THE APPENDED DRAWINGS

FIG. 1 illustrates a cross-sectional view of the back iron frame structure of the conventional backlight module in a prior art.

FIG. 2 illustrates a cross-sectional view of the design of reducing the back frame area.

FIG. 3A illustrates a cross-sectional view of the front frame structure of the conventional backlight module in a prior art.

FIG. 3B illustrates a schematic diagram of pulling the PBCA plate in FIG. 3A downward and inserting the sensing plate S.

FIG. 4 illustrates a cross-sectional view of the touch display apparatus along X-X line and Y-Y line in a preferred embodiment of the invention.

### DETAILED DESCRIPTION OF THE INVENTION

A preferred embodiment of the invention is a touch liquid crystal display (LCD) apparatus. In this embodiment, the touch display apparatus at least includes a display panel, a backlight module, a sensing plate, and a touch panel. Wherein, the backlight module can be an edge-type backlight module applied in a LCD, but not limited to this.

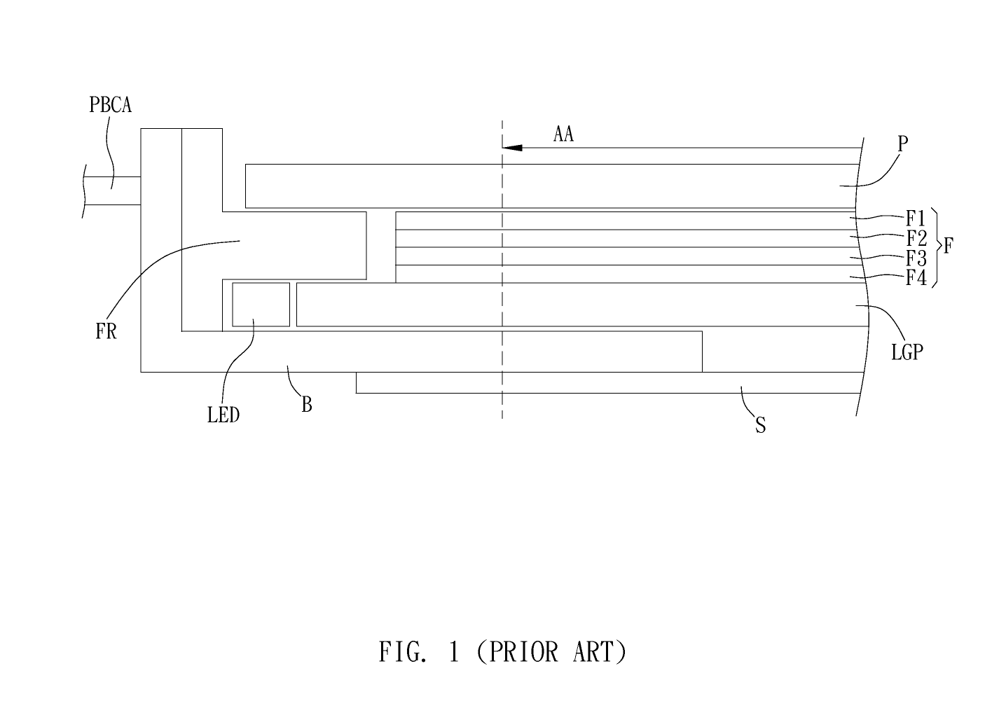

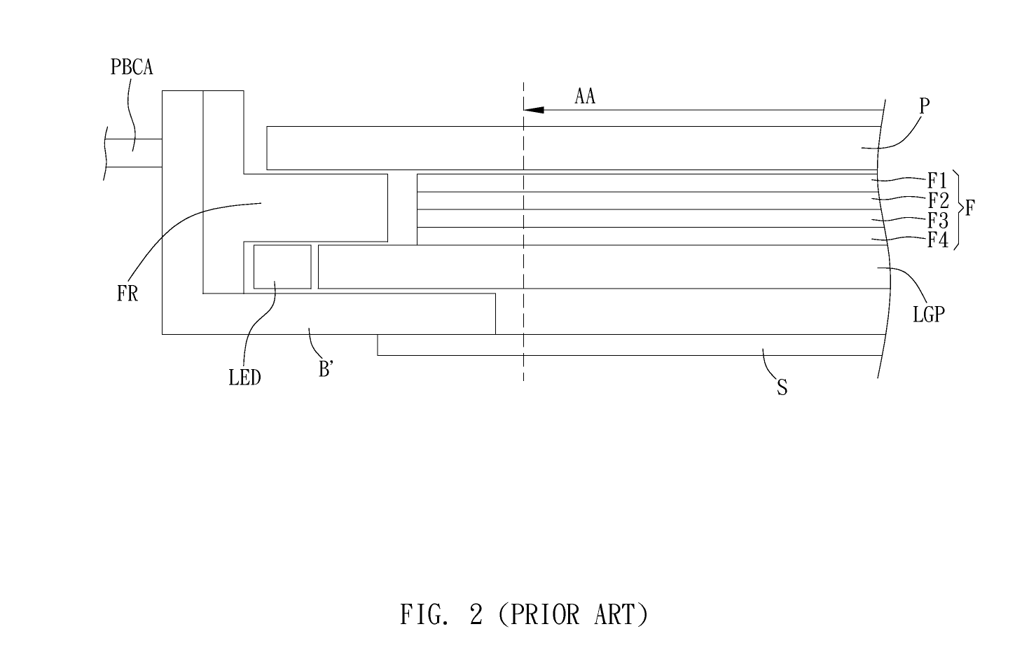

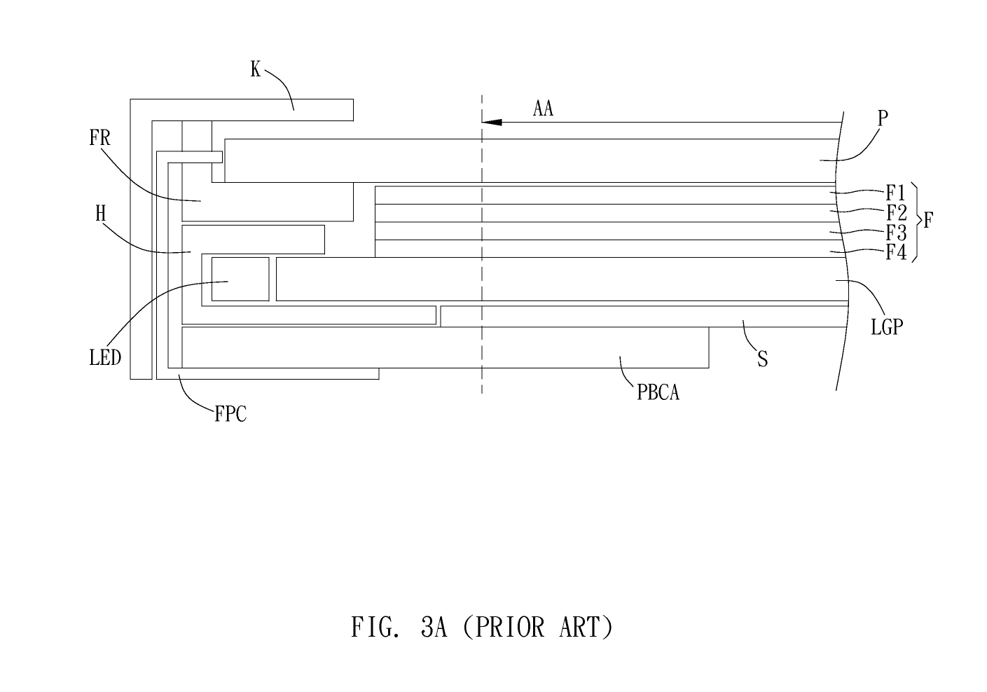

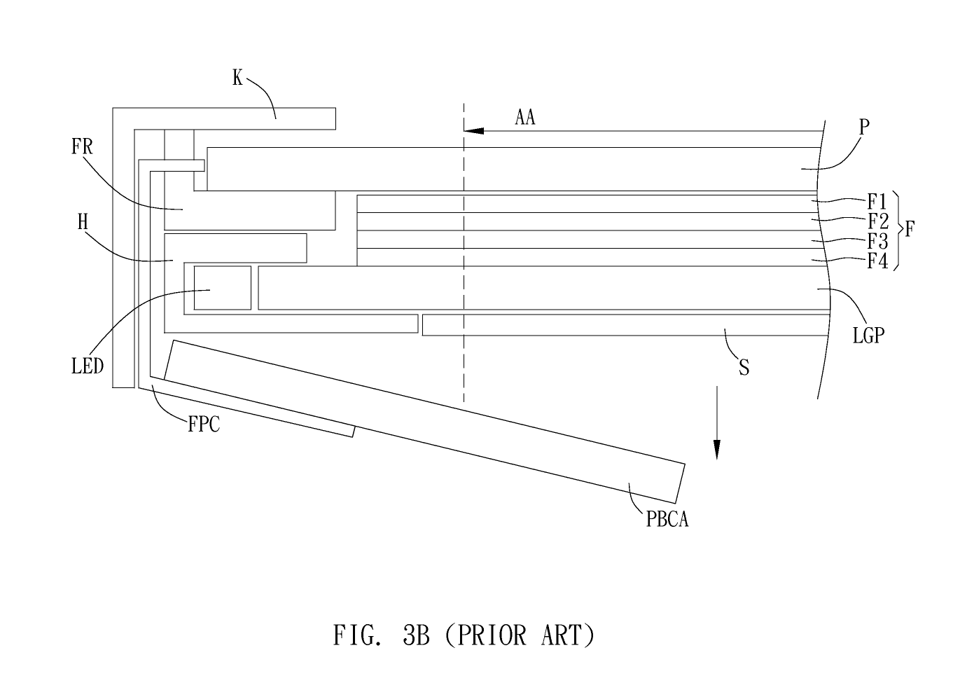

Some problems of the conventional design are found. In FIG. 1, if there is metallic material existed between the sensing plate S and the active area AA of the display panel P, the sensing of the sensing plate S will be interfered. Thus, the drawback of this structure is that because the area of the back iron frame B is too large, the back iron frame B extends to the space between the sensing plate S and the active area AA of the display panel P, and the sensing of the sensing plate S will become poor due to the interference of the metallic material. In FIG. 2, although this design can prevent the sensing of the sensing plate S from being poor due to the interference of metallic material, the strength of the entire back iron frame B′ is also reduced and fails to effectively support the weight of entire backlight module. Therefore, the above-mentioned design of the back iron frame B′ and the sensing plate S is almost not used in current products. In FIG. 3, in order to dispose the sensing plate S under the active area AA of the display panel P, the area of the frame of the holder H must be reduced, and the support strength of the holder H will become weaker. In addition, as shown in FIG. 3B, in practical assembling process, the PBCA must be pulled downward at first, and then the sensing plate S is inserted, not only the assembling time is increased, but also the flexible printed circuit (FPC) is bent and damaged due to the downward pulled PBCA.

From the above, the iron frame structure used in current backlight module of the panel still has many problems and drawbacks to be overcome. Therefore, a scope of the invention is to provide a touch Display apparatus to solve the above-mentioned problems.

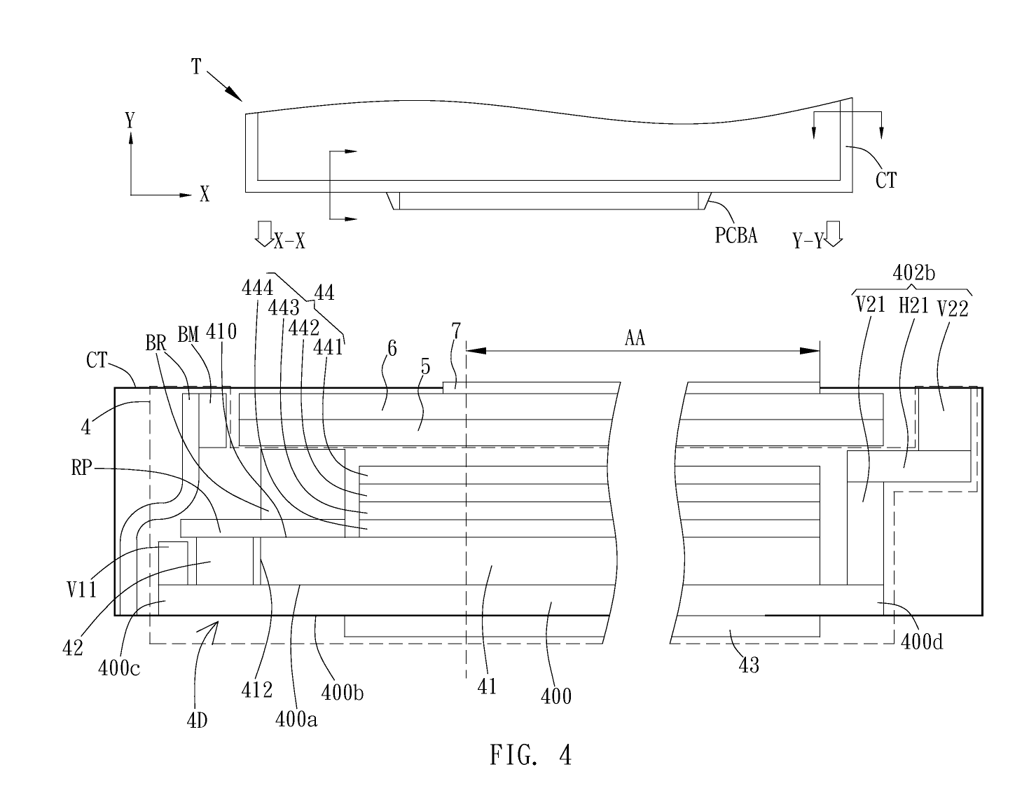

Please refer to FIG. 4. FIG. 4 illustrates a cross-sectional view of the touch display apparatus T along X-X line and Y-Y line in a preferred embodiment of the present application. As shown in FIG. 4, the touch display apparatus T includes a backlight module 4, a plastic frame CT, a sensing plate 43, a display panel 5, a touch panel 6, and a protecting glass 7. The display panel 5 is disposed above the backlight module 4; the sensing plate 43 is disposed under the backlight module 4; the touch panel 6 is disposed above the display panel 5; the protecting glass 7 is disposed above the touch panel 6; the plastic frame CT is disposed to enclose the periphery of the backlight module 4 and the top of the touch panel 6, but the plastic frame CT is not necessary to cover the protecting glass 7.

In this embodiment, the backlight module 4 includes a support member 4D, a light guide plate 41, a backlight source 42, an optical film set 44, a bracket BR, a reflecting plate RP, and a buffer member BM. Wherein, the support member 4D is formed by a non-metallic material. In fact, the non-metallic material forming the support member 4D can be a foam-type Polyethylene Terephthalate (PET), such as Micro Cellular Polyethylene Terephthalate (MCPET), but not limited to this. The reflecting plate RP is disposed above the backlight source 42 and a part of the light guide plate 41, and the reflecting plate RP is formed by a light reflecting material.

The bracket BR is disposed between the reflecting plate RP and the display panel 5, and between the outside of the support member 4D near the backlight source 42 and the plastic frame CT, and the bracket BR is formed by a metallic material. The buffer member BM is disposed between the bracket BR and the display panel 5 and between the bracket BR and the touch panel 6.

The support member 4D has a bottom 400 and a plurality of sidewalls V11, 402b, the sides of the bottom 400 respectively connects with the plurality of sidewalls V11, 402b to form a containing space. For example, if the bottom 400 of the support member 4D is a quadrilateral, and the four sides of the bottom 400 connect with the four sidewalls V11, 402b respectively to form the containing space, but not limited to this. The thickness of the bottom 400 of the support member 4D and the sidewalls V11 can be adjusted based on practical needs without any specific limitations.

The light guide plate 41 is disposed in the containing space defined by the sides of the bottom 400 and the sidewalls V11, 402b. In more detail, the light guide plate 41 is disposed on the top surface 400a of the bottom 400. The light guide plate 41 has a light emitting surface 410, and one side of the light emitting surface 410 has a light incident end 412.

The backlight source 42 is disposed in the containing space and corresponds to the light incident end 412 of the light guide plate 41. The backlight source 42 is used to generate lights emitting to the light incident end 412. In more detail, the backlight source 42 is disposed on the top surface 400a of the bottom 400 and corresponds to the light incident end 412 of the light guide plate 41. The lights of the backlight source 42 is emitted to the light incident end 412 and entered into the light guide plate 41, and emitted out upward from the light emitting surface 410 of the light guide plate 41. If the lights of the backlight source 42 are emitted to the reflecting plate RP, the reflecting plate RP will reflect the lights into the light guide plate 41. In practical applications, the backlight source 42 can be a LED, but not limited to this.

The sensing plate 43 is disposed under the lower surface 400b of the bottom 400 and the plastic frame CT, and senses the motion of the object above the touch panel 6 through the electromagnetic reaction. In fact, the sensing plate 43 can be an electromagnetic induction type tablet, and it can be disposed under the lower surface 400b of the bottom 400 and the plastic frame CT by an adhering way or other ways, but not limited to this. The position that the sensing region of the sensing plate 43 disposed under the lower surface 400b of the bottom 400 and the plastic frame CT corresponds to the active area AA of the display panel 5, but not limited to this.

The optical film set 44 is disposed above the light emitting surface 410 of the light guide plate 41. In this embodiment, the optical film set 44 includes four layers of optical films 441444: an upper diffusion film 441, an upper prism film 442, an lower prism film 443, and an lower prism film 444 from top to bottom respectively, for example. That is to say, the lower prism film 444 is nearest to the light emitting surface 410 of the light guide plate 41, and the upper diffusion film 441 is farthest to the light emitting surface 410 of the light guide plate 41. In fact, the number, types, and thickness of the optical films of the optical film set 44 can be determined based on practical needs and not limited to the diffusion film and the prism film of this embodiment.

As shown in FIG. 4, in this embodiment, four sidewalls V11 and 402b of the support member 4D include a first sidewall V11 and three second sidewalls 402b. Wherein, the first sidewall V11 connects with the first side 400c of the bottom 400 of the support member 4D, and the first sidewall V11 is adjacent to the backlight source 42. The three second sidewalls 402b connect with other second sides 400d of the bottom 400 respectively, and the three second sidewalls 402b is adjacent to the light guide plate 41 and the bracket BR. That is to say, the position that the backlight source 42 is disposed on the upper surface of the bottom 400 is near to the first sidewall V11.

In this embodiment, the first sidewall V11 at least includes a sidewall portion (as shown in FIG. 4), but not limited to this. The bottom end of the first sidewall V11 connects with the bottom 400 of the support member 4D. Each second sidewall 402b at least includes a first sidewall portion, a second sidewall portion, and a third sidewall portion, such as the first vertical member V21, the horizontal member H21, and the second vertical member V22 shown in FIG. 4, but not limited to this. Two ends of the first vertical member V21 connect with the bottom 400 of the support member 4D and the horizontal member H21 respectively, and the two ends of the horizontal member H21 connect with the first vertical member V21 and the second vertical member V22 respectively.

Through the above-mentioned design, the bottom 400 of the support member 4D disposed between the sensing plate 43 and the display panel 5 does not include any metallic material, therefore, the area of the bottom 400 of the support member 4D is not necessary to be reduced in order to cooperate with the sensing plate 43. Thus, the support member 4D can maintain some supporting strength, and when the sensing plate 43 performs sensing process, it will not be interfered by metallic material to effectively solve the problems occurred in prior art.

Display panel 5 of the embodiment of the present application is not limited thereto. Display panel 5 may be LCD, PDP, OLED display, EPD etc.

Compared to the prior art, the touch display apparatus of the invention can effectively improve the metal interference issue of the conventional sensing plate, and the micro cellular polyethylene terephthalate (MCPET) without any metallic material is used as supporting structure of its backlight module, so that the back iron frame, the reflection film, and the rubber frame in the conventional backlight module structure can be integrated and combined with the metal bracket at the LED backlight source side. Therefore, the assembling time, material types, and weight can be reduced and the strength and assembling convenience can be also considered at the same time to solve the problems occurred in prior art.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch display apparatus, comprising:
a backlight module, comprising:
a support member, formed by a non-metallic material, the support member having a bottom and a plurality of sidewalls, wherein sides of the bottom connecting with the plurality of sidewalls respectively to form a containing space;
a light guide plate, disposed in the containing space, the light guide plate having a light emitting surface, and a side of the containing space having a light incident end; and
a backlight source, disposed corresponding to the light incident end in the containing space, the backlight source generating a light and the light being emitted to the light incident end; and
a sensing plate, disposed on a lower surface of the bottom, the sensing plate sensing an action of an item above the support member through an electromagnetic reaction.

2. The touch display apparatus of claim 1, wherein the non-metallic material is a foam-type Polyethylene Terephthalate (PET).

3. The touch display apparatus of claim 1, wherein the plurality of sidewalls comprises:
a first sidewall, connected with a first side of the bottom and adjacent to the backlight source; and
a plurality of second sidewalls, connected with other sides of the bottom respectively and adjacent to the light guide plate.

4. The touch display apparatus of claim 3, wherein the first sidewall at least comprises a sidewall portion and an end of the sidewall portion connects with the bottom.

5. The touch display apparatus of claim 3, wherein each second sidewall at least comprises a first sidewall portion, a second sidewall portion, and a third sidewall portion, two ends of the first sidewall portion connect with the bottom and the second sidewall portion respectively, and two ends of the second sidewall portion connect with the first sidewall portion and the third sidewall portion respectively.

6. The touch display apparatus of claim 1, wherein the sensing plate is disposed on the lower surface of the bottom by an adhering way, and the sensing plate is an electromagnetic induction type tablet.

7. The touch display apparatus of claim 1, further comprising:
a display panel, disposed above the backlight module.

8. The touch display apparatus of claim 7, wherein the location of a sensing region of the sensing plate disposed on the lower surface corresponds to a viewing area of the display panel, and edges of the display panel are disposed on horizontal portions of the plurality of sidewalls respectively.

9. The touch display apparatus of claim 7, further comprising:
a touch panel, disposed above the display panel.
